(19) United States
(12) Patent Application Publication
(10) Pub. No.: US 2023/0042517 A1
(43) Pub. Date: Feb. 9, 2023

(54) Transportable Slurry Box Method of Use

(71) Applicant: Ryan Peterkin, Nikiski, AK (US)

(72) Inventor: Ryan Peterkin, Nikiski, AK (US)

(21) Appl. No.: 17/531,989

(22) Filed: Nov. 22, 2021

Related U.S. Application Data
(63) Continuation-in-part of application No. 17/396,403, filed on Aug. 6, 2021.

(51) Int. Cl. B60P 3/22; B65D 81/20; B65D 81/38; B65D 88/74; B65D 90/06; B65D 90/18

(52) U.S. Cl. CPC B60P 3/2295; B60P 3/2205; B60P 3/226; B65D 81/2015; B65D 81/3813; B65D 88/744; B65D 88/748; B65D 90/06; B65D 90/18

(57) ABSTRACT

A method for using a heated portable vacuum slurry box to efficiently store and transport material including drill cuttings from gas and oil well sites. The slurry box generally includes a vacuum tank, a structure attached to the tank, a vertical tailgate, and a hook for pulling the slurry box onto a vehicle. The features allow for the slurry box to be meet space restriction requirements at a well site while as well as function within the environmental conditions of winter and summer seasons. The method includes a preferred method to unload the slurry box.

### CROSS-REFERENCE TO RELATED APPLICATION(S)

This application claims the priority as a continuation-in-part to U.S. Nonprovisional patent application Ser. No. 17/396,403, filed Aug. 18, 2021, the contents of which are hereby incorporated by reference in its entirety.

### FIELD OF TECHNOLOGY

This disclosure relates generally to technology for roll-off self-contained cutting boxes for heated slurry transport, receiving, and dumping in cold climates with freezing temperatures.

### BACKGROUND

Drill cuttings are produced during drilling of oil wells and gas wells. The drill cuttings are carried to the surface by a drilling fluid circulating up from the drill bit. The drill cuttings are separated from the drilling fluid so the recycled drilling fluid may be reused during the drilling process. The separated drill cuttings along with a portion of the drilling fluid and other fluids form a cuttings slurry that is often transported to a vacuum tank for holding until full. Once the tank is full of the cuttings slurry, the cuttings slurry is transported to a disposal site.

One problem with conventional transporting slurry cuttings in a vacuum tank is that the cuttings slurry may freeze in cold weather environments such as Alaska, cold climate states and Canada, making it difficult to unload the cuttings slurry from the vacuum box. To solve this problem one solution is to provide heat energy to keep the slurry cuttings from freezing. One example of a heat solution is illustrated in U.S. Pat. No. 10,933,794 to Peterkin titled “Heated slurry transport system.”

Vacuum tanks must be removed from oil and gas well sites in a timely manner such to not impede the function of a drilling rig at an oil or gas well site. Such sites are limited in space and storing many vacuum tanks on the oil or gas well site is not possible with current vacuum tank systems. Further portable vacuum tanks which are too large do not fit the requirements to be efficiently emptied at disposal sites. In the warm summer months, poor road conditions cause excess wear on equipment. Transporting vacuum tanks with heating functions over summer roads during times of the year when the heating functions are unneeded unnecessarily causes wear on such equipment.

### SUMMARY

The present invention disclosed herein comprises a method that allows for the efficient use of a slurry box. The method reduces the manhours required to load slurry cuttings from an oil rig and dispose of the slurry cuttings. The method is primarily used in cold climates. Slurry cuttings which are filled into a slurry box are transported for the purpose of unloading to dispose of the slurry cuttings. The method herein discloses a particular method of use for the slurry box.

The disclosed process details a method in which a transportable slurry box may be used to transport slurry cuttings from an oil rig site to a disposal facility. The slurry box is filled with slurry cuttings, transported to a disposal facility, and unloaded at the disposal facility. All process steps may be done while the slurry box is configured to maintain the slurry cuttings at a temperature such as not allowing the slurry cuttings to freeze. Maintaining the slurry cuttings at a temperature above freezing saves the cost and time needed for dethawing. In the summer months, the heating function of the slurry box is not needed.

An oil rig must continually dispose of slurry cuttings to operate. When inclement weather becomes present, the inclement weather may cause the oil rig operator to be unable to transport to and from an oil rig site. Multiple slurry boxes as disclosed herein may be stored at an oil rig site to allow the oil rig to continue operating during inclement weather. The slurry box may keep the slurry cuttings above freezing temperatures.

Slurry boxes may be stored at the oil rig site after being filled and before being transported to the disposal facility. An oil rig operator may want to store filled slurry boxes at an oil rig facility when inclement weather does not allow for transportation or for other reasons the slurry boxes can not be transported.

The primary steps in the disclosed method generally comprises of placing the slurry box at an oil rig site; connecting the slurry box to the outlet of the oil rig; charging the vacuum tank with vacuum pressure; filling the vacuum tank with slurry cuttings; loading the slurry box onto a vehicle; transporting the slurry box to a disposal facility; unloading the vacuum tank; transporting the slurry box to an oil rig site; and delivering the slurry box at an oil rig site.

The unloading step further comprises the steps of positioning the slurry box at a location at the disposal facility; draining fluid from the slurry box; opening the tailgate on the slurry box; dumping the slurry box; and cleaning the slurry box.

The method as disclosed herein is related to using a self-contained heated portable vacuum slurry box. The slurry box is such that it can be placed on a vehicle for transportation or moved at a particular location. An example of a vehicle used with the slurry box is a traditionally understood roll-off truck. With this method, the slurry box can be loaded to or delivered with a roll-off truck. The vacuum tank comprising the slurry box is such that it can hold a vacuum when a vacuum pump is fluidly attached to the tank. The vacuum can cause material such as slurry cuttings to be pulled into the portable tank.

### BRIEF DESCRIPTION OF THE DRAWINGS

These and other features and advantages of the present invention will become more readily appreciated as the same becomes better understood by reference to the following detailed description when considered in connection with accompanying drawings, wherein:

FIG. 1 is a simplified block diagram showing the method in which a slurry box is used efficiently;

FIG. 2 is a 2D perspective of an exemplary slurry box mounted on a vehicle;

FIG. 3 is a 3D perspective of an exemplary slurry box connected at an oil rig;

FIG. 4 is a 3D perspective of two slurry boxes stacked on top of each other;

FIG. 5 is a simplified block diagram showing the method in which a slurry box is unloaded;

FIG. 6 is a 2D perspective of an exemplary slurry box in a raised position;

FIG. 7 is a 2D perspective of an exemplary slurry box and vehicle.

### DETAILED DESCRIPTION OF THE ILLUSTRATED EMBODIMENTS

### General

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

### Figures Detail

The slurry box as described in U.S. Nonprovisional patent application Ser. No. 17/396,403, filed Aug. 18, 2021, and the vacuum box as defined in U.S. Pat. No. 10,933,794 to Peterkin titled “Heated slurry transport system”, both contents of which are hereby incorporated by reference in its entirety, define the slurry box 201 as referenced in herein.

The slurry box 201 is such that it can be placed on a vehicle 202 for transportation or moved at a particular location. For example, a vehicle can be a self-loading vehicle which can pull the slurry box 201 onto the vehicle 202. An example of a vehicle 202 that can be used with the slurry box 201 is a traditionally understood roll-off truck. With this invention, the slurry box 201 can be loaded or unloaded from a vehicle 202. The slurry box 201 is comprised of at least a vacuum tank that can be loaded upon a vehicle 202. The vacuum tank is such that it can hold a vacuum when a vacuum pump is fluidly connected to the vacuum tank. The vacuum can cause material such as drilling cuttings to be filled into the portable vacuum tank.

A slurry box 201 in other embodiments also comprises a vertical tailgate which allows for the slurry box 201 to be unloaded in a compact space and the capability to heat the contents of the slurry box 201 to a temperature above freezing. The heating capability may be by the circulation of a heated flow of liquid through pipes distributed through the slurry box 201 with a particular design that doesn't impede the payload to slide out. Multiple slurry boxes may be stacked to conserve room on a well site.

In summer months, the heating function of the slurry box 201 is not needed. In summer months, roads which were frozen during winter months have thawed and become rough, therefore causing additional wear and tear on equipment being transported thereon.

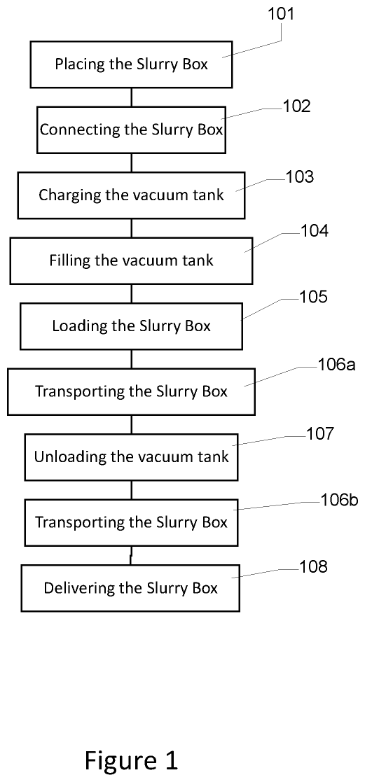

FIG. 1 is a simplified block diagram showing the method in which a slurry box 201 is used efficiently. The disclosed method comprises placing 101 the slurry box 201 to be connected to an oil rig; connecting 102 the slurry box 201; charging 103 the vacuum tank comprising the slurry box 201; filling 104 the vacuum tank; loading 105 the slurry box 201 onto a vehicle 202; transporting 106a the slurry box 201 to a disposal facility; unloading 107 the vacuum tank; transporting 106b the slurry box 201 to an oil rig site; and delivering 108 the slurry box 201 at an oil rig site. For the purpose of this application, an oil rig site refers to a drill site which may be either an oil or gas rig site. For this application, an oil rig refers to either an oil or gas rig.

The steps as described and shown in FIG. 1 need not start with placing 101 the slurry box 201; rather the disclosed method can start and end at any step within the disclosed process. For example, the disclosed method may start with transporting 106b the slurry box 201 to an oil rig site and end with unloading 107 the slurry box 201 at a disposal site.

The step of placing 101 a slurry box 201 at an oil rig site includes the act of moving the slurry box 201 to a location near the oil rig such that allows for the slurry box 201 to be connected to a vacuum source, and the inlet of the slurry box 201 to be connected to the slurry cutting outlet attached to the oil rig. The operator of the oil rig typically designates the location at which the slurry box 201 is placed. The location at which the slurry box 201 is placed may be different from where the slurry box 201 is delivered 108 to the oil rig site. The slurry box 201 may be moved from a storage location designated at the oil rig site to the location at which the slurry box is to be placed 101. Slurry boxes may be stacked vertically at the oil rig site for storage purposes. The slurry box 201 may be removed from a stack and then placed 101.

Alternatively, vehicle 202 may deliver 108 a slurry box 201 to an oil rig site in a way that the vehicle 202 places 101 the slurry box 201. The vehicle 202 may have the capability to self-load and self-unload. When a vehicle 202 which is delivering 108 the slurry box 201 places 101 the slurry box 201, the slurry box 201 is not being moved from a storage location on the oil rig site. Rather it is being placed 101 directly from the vehicle 202.

The step of connecting 102 a slurry box 201 is the act of configuring the inlet of the vacuum tank to be fluidly attached to the slurry cutting outlet attached to the oil rig, and fluidly attaching the vacuum port to a vacuum source. When a slurry box 201 is properly placed 101 at an oil rig site, the connecting 102 step can occur.

An inlet on the slurry box 201 is an opening in the vacuum tank through which slurry cuttings can flow into the vacuum tank from a pipe or hose. The inlet is configured such that it can fluidly seal to the slurry cutting outlet of the oil rig. Typically, the inlet will be comprised of a flanged pipe or quick connect hose. However, when not fluidly attached to the outlet, the inlet may be fluidly sealed to not allow debris to enter the vacuum tank.

A vacuum port on the slurry box 201 is an opening in the vacuum tank through which a vacuum source may charge 103 the vacuum tank with a vacuum. The vacuum port is configured such that it can fluidly seal to a vacuum source. Typically, the vacuum port will be comprised of a flanged pipe or quick connect hose. However, when not fluidly attached to the vacuum source, the vacuum port may be fluidly sealed such to not allow debris to enter the vacuum tank.

A vacuum source is provided by a vacuum pump located at the oil rig site. The vacuum pump is sized accordingly such that it can remove air from the vacuum tank such that the vacuum tank becomes under vacuum pressure. The vacuum pump can be a stand-alone unit designated for use with slurry boxes, or can be a vacuum pump used for purposes beyond the slurry box 201. The vacuum pump can be driven by electric energy, an internal combustion engine, a diesel engine, or any other power source.

Drill cuttings are produced during drilling of oil wells and gas wells. The drill cuttings are carried to the surface by a drilling fluid circulating up from the drill bit. The drill cuttings are separated from the drilling fluid so the recycled drilling fluid may be reused during the drilling process. The separated drill cuttings and a portion of the drilling fluid and other liquids form a cuttings slurry that must be removed from the oil rig site. Slurry cuttings are expressed from the oil rig through an outlet. The outlet may be pumped from the oil rig itself, mud pits, or a holding tank. In the disclosed process herein, the outlet must be configured to fluidly attach to the inlet of the slurry box 201.

The step of charging 103 the slurry box 201 is the act of pulling a vacuum on the vacuum tank. Once the slurry box 201 is connected 102, the vacuum tank is fluidly sealed from the atmosphere and the only external connections attached to the vacuum tank are through the inlet and vacuum port. When the vacuum tank is sealed from the atmosphere, a vacuum can be charged 103 to the tank. For the sake of this application, charging a vacuum is understood to be the act of removing air from the vacuum tank and therefore reducing the creating a negative pressure within the vacuum tank. Vacuum Pressure is the state in which the vacuum tank is in when in a vacuum. When at vacuum pressure, the vacuum tank is charged to a pressure that is less than atmospheric pressure and less than the pressure in the slurry cutting outlet, such that slurry cuttings may be filled 104 into the slurry box 201. The vacuum can range from slightly below atmospheric pressure to a full vacuum, depending on how quickly the oil rig operator wishes the slurry cuttings to flow into the vacuum tank. The vacuum pump can be configured to continue to charge 103 vacuum pressure into the vacuum tank until the vacuum tank is filled with slurry cuttings to such a level as desired by the oil rig operator or transport operator.

The step of filling 104 the vacuum tank is to allow slurry cuttings to be pulled into the vacuum tank by the force of the vacuum pressure charged 103 into the vacuum tank. As slurry cuttings are pulled into the vacuum tank, the vacuum pump can continue to charge 103 the vacuum tank until the desired level of slurry cuttings is filled into the vacuum tank. An exterior fill level gauge may be configured on the slurry box 201. By watching the exterior level gauge, the operator may visually monitor the amount of slurry cuttings filling the slurry box 201 so to ensure the slurry box 201 is not overfilled beyond the intended amount per load.

Once the vacuum tank on the slurry box 201 is filled 104 to the desired level, the slurry box 201 may be disconnected from the oil rig slurry cuttings output and disconnected from the vacuum source. The slurry box 201 may then be moved to another location at the oil rig site or directly loaded 105 onto a vehicle 202. Moving the slurry box 201 to another location at the oil rig site allows for a different slurry box 201 to be placed 101 to connect 102. Slurry boxes that are moved to another location at the oil rig site are placed in a location for storage. While in storage, the oil rig operator can choose to stack multiple slurry boxes vertically.

Stacking slurry boxes help consolidate the amount of land area needed at an oil rig site. The slurry box 201 may be stacked vertically when more than one slurry box 201 is used. Many gas or oil rig sites have limited space on which equipment can be placed and the ability to stack the slurry boxes is a valuable function. The slurry box 201 may be lifted using d-rings, slings cables, or chains, a forklift, or any other lifting mechanism. The slurry box 201 is only moved into a storage location for a temporal period and will eventually be loaded 105 onto a vehicle 202.

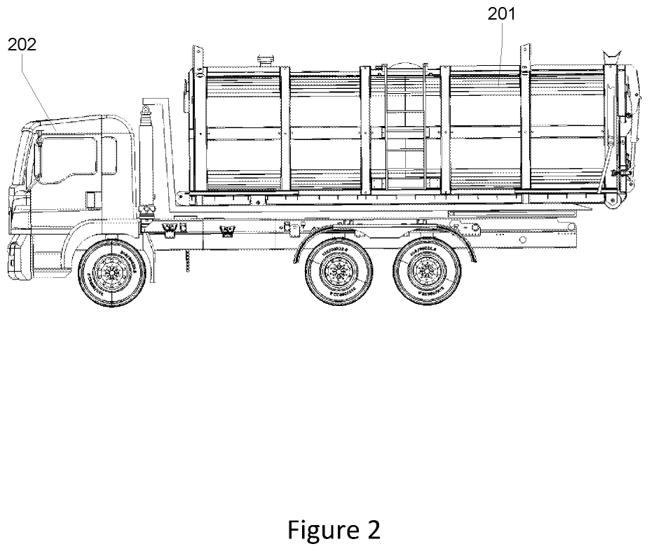

The step of loading 105 a slurry box 201 onto a vehicle 202 is the act of lifting the slurry box 201 onto a vehicle 202. An exemplary vehicle 202 is shown in FIG. 2 and the scope of what defines a vehicle 202 is discussed in FIG. 2's discussion. The slurry box 201 may be loaded 105 onto a vehicle 202 by force exerted from a pulling object. For example, a roll-off type vehicle could use a winch, a hydraulic ram, or a hook arm to pull the slurry box 201 onto the vehicle 202. Alternatively, the slurry box 201 may be loaded 105 onto a vehicle 202 by lifting the slurry box 201 with an external device. For example, a forklift or a crane could pick up the slurry box 201 and load it onto the vehicle 202.

The step of transporting 106a the slurry box 201 to a disposal facility is the act of physically moving the slurry box 201, which has been loaded 105 on a vehicle 202 from the oil rig site to the disposal facility where it will be unloaded 107. The slurry box 201 is transported 106 on a vehicle 202 at two times in the method of use. The function of transporting 106a the slurry box 201 to the disposal facility and transporting 106b the slurry box 201 to the oil rig site essentially comprise the same functions and are both considered transporting 106.

Transporting 106 the slurry box 201 can be performed by a vehicle 202 which is motorized, or can be performed by pulling the vehicle 202 with another device. The transporting 106 function can be performed over a wide geographic region or may be a relatively short distance. The transporting 106 function may also include one or more transitions wherein the slurry box 201 loaded 105 on the vehicle 202 is removed from the vehicle 202 and placed on another alternative vehicle 202. For example, a slurry box 201 might be loaded 105 on a vehicle 202 at the oil rig site which is of a sled embodiment. Once the slurry box 201 is transported 106 a certain distance, the slurry box 201 may be transitioned onto a vehicle 202 of a roll-off embodiment. At this point, the slurry box 201 continues to be transported 106 to the disposal facility. During the transporting 106 function, the slurry box 201 may be transitioned multiple times. Different vehicles may be used for different portions of the transporting steps.

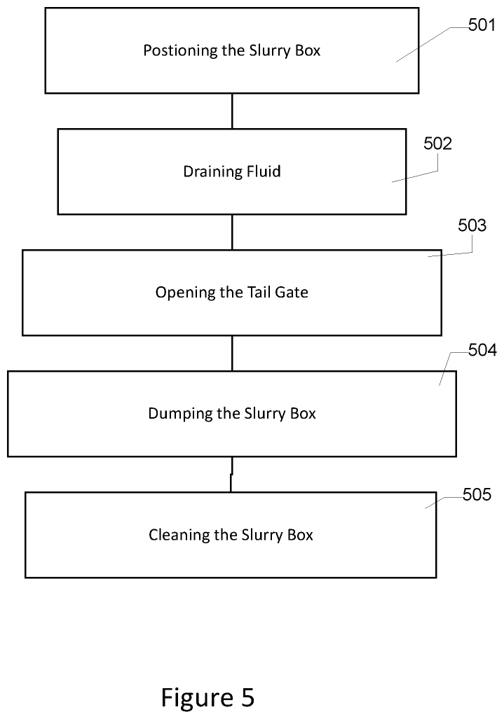

The step of unloading 107 the slurry box 201 is emptying the slurry cuttings from the vacuum tank within the slurry box 201. Once the slurry box 201 has been transported 106a to the disposal facility, the slurry box 201 is positioned at a location at the disposal facility wherein the slurry box 201 is to be unloaded 107. Multiple methods can be employed to unload 107 the vacuum tank within the slurry box 201. Methods to unload 107 include but are not limited to dumping, using vacuum force, or scooping the cuttings slurry from the vacuum tank. A preferred method of unloading 107 the slurry box 201 is detailed in FIGS. 5-7 and the accompanying description herein.

The step of transporting 106b the slurry box 201 to an oil rig site is the act of physically moving the slurry box 201 on a vehicle 202 from the disposal facility to the oil rig site.

The step of delivering 108 the slurry box 201 to the oil rig site is to remove the slurry box 201 from the vehicle 202 upon which the slurry box 201 was transported 106. The slurry box 201 may be delivered 108 at a location at the oil rig site used for storage or may be delivered 108 to the location at the oil rig site wherein the slurry box 201 will be placed 101. If the slurry box 201 is delivered at a location used for storage, the slurry box 201 may be stacked.

FIG. 2 is a 2D perspective of an exemplary slurry box 201 mounted on a vehicle 202. In the embodiment shown in FIG. 2 the slurry box 201 is shown to be similar to a roll-off container. A roll-off container is a portable container that may be transported on a vehicle 202. In the figure, the slurry box 201 is shown similar to a cable-type roll-off container. A cable-type roll-off container may be pulled or placed on a vehicle such as a tilt-bed vehicle or trailer using a winch hydraulic rams with cables. A cable attached to the winch may be attached to a hook point on the slurry box 201. The slurry box 201 may then be loaded 105 onto the vehicle 202 utilizing pulling force from the cable. In an alternative embodiment, the slurry box 201 may be built to allow the hook point to be attached near the top of the slurry box 201 to allow for a hook-loader type vehicle to load 105 the slurry box 201 onto the vehicle 202. For this disclosure, a roll-off vehicle is considered to be either a tilt-bed vehicle, a truck-trailer combination, a hook-loader, or a cable type vehicle. A truck-trailer combination-type vehicle is a vehicle 202 where a truck pulls a trailer, the trailer which is a hook-loader type trailer or a tilt-bed type trailer. In a truck-trailer combination, the slurry box 201 is pulled onto the trailer section of the truck-trailer combination just as a slurry box 201 is pulled onto a tilt-bed vehicle or a hook-loader type vehicle.

Alternatively, the vehicle 202 may be a sled configured to be transported in snowy and icy conditions. The sled is configured to handle both the weight and size of the slurry box 201 after being filled 104. Commonly a sled configured to be used in snowy and icy conditions is pulled by a snowcat tracked vehicle.

The slurry box 201 is sized to fit onto a vehicle 202. The slurry box 201 may be built in various sizes and shapes to accommodate different vehicles. An exemplary slurry box 201 may be 2.26 meters (89 inches) wide by 7.37 meters (290 inches) long. A slurry box 201 with such dimensions would be compliant with various jurisdictional transportation requirements.

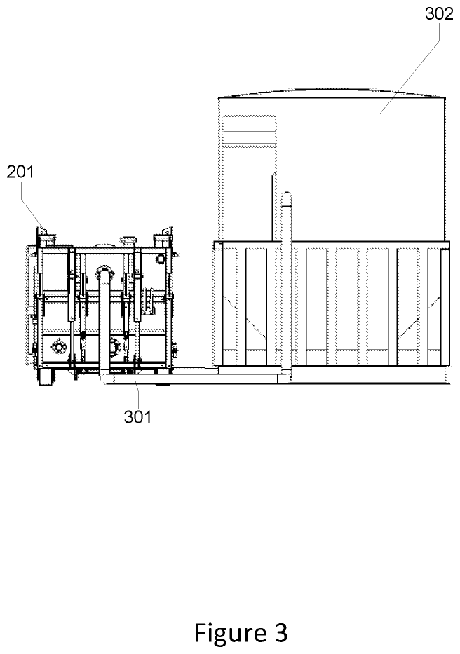

FIG. 3 is a 3D perspective of an exemplary slurry box 201 connected 102 at an oil rig site. Shown in the figure is a pipe 301 connected from the vacuum port to a vacuum source 302. Additional pipe or hose is connected from the outlet to the oil rig such the slurry cuttings may be filled into the slurry box 201.

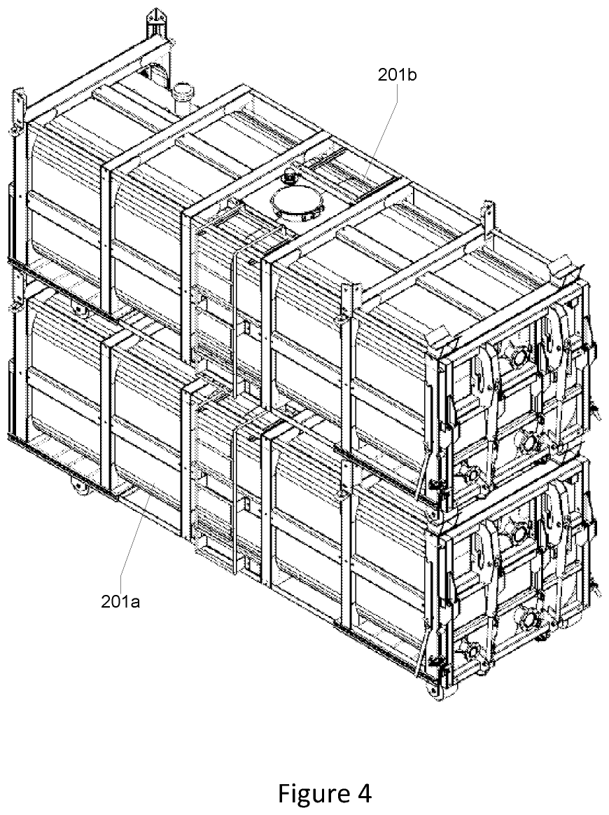

FIG. 4 is a 3D perspective of two slurry boxes stacked on top of each other. Shown in the figure is a bottom slurry box 201a and an upper slurry box 201b. The slurry boxes are stacked on top of each other to save space. More than two slurry boxes may be stacked.

FIG. 5 is a simplified block diagram showing the method in which a slurry box 201 is unloaded 107. The disclosed method comprises positioning 501 the slurry box 201 at a location at the disposal facility; draining 502 fluid from the slurry box 201; opening 503 the tailgate on the slurry box 201; dumping 504 the slurry box 201; and cleaning 505 the slurry box 201. The slurry box 201 may be placed where it is stored, transported 106 to an oil rig site, or used for other purposes.

The step of positioning 501 the slurry box 201 at a disposal facility location is moving the slurry box 201 to the place where the slurry box 201 may be emptied of slurry cuttings. Often the disposal facility is constructed such that the slurry box 201 must be positioned 501 in a location that does not allow for excess space horizontally around the vehicle 202 and slurry box 201. This effectively means that a slurry box 201 will not have excess room to open a tailgate horizontally; rather the slurry box 201 is better suited to be opened vertically.

The step of draining 502 the slurry box 201 is the act of emptying the slurry box 201 of unconstrained fluid. The unconstrained fluid may be free-standing on the surface of the slurry cuttings or may be within the slurry cuttings. Draining 502 the slurry box 201 is comprised of opening an orifice in the vacuum tank and tilting the slurry box such that the fluid flows through the orifice out of the vacuum tank. The orifice used to drain the fluid may be the inlet of the slurry box 201 used for filling 104 the vacuum tank.

An elbow, hose, or other fitting may be attached to the opening, such as the inlet, to direct the fluid as it is emptied from the vacuum tank. A valve may be used to control the flow of fluid and cuttings slurry from the vacuum tank. When the slurry box 201 is on a roll-off vehicle, the slurry box 201 may undergo the step of sliding the box back toward the rear of the vehicle 202 to accommodate for draining 502 and dumping 504. In such roll-off vehicle applications, the slurry box 201 is typically slid approximately 2.4 meters (8 feet) toward the rear of the vehicle 202. To facilitate the draining 502 step, the vehicle 202 may be configured to raise the slurry box 201 such that one end of the slurry box 201 is higher than the end which is opened to empty fluid from the vacuum tank. The raising of the slurry box 201 is essentially the same function as commonly used by dump trucks. Raising one end of the slurry box 201 is considered tilting the slurry box 201. Once the requisite amount of unconstrained fluid is emptied from the vacuum tank, as determined by the vehicle 202 operator, the slurry box 201 may be lowered back to a horizontal position.

The step of opening 503 the tailgate on the slurry box 201 is the act of causing the tailgate to be opened. At the rear of the slurry box 201 a tailgate is attached. The tailgate is attached to hinges on the slurry box 201, allowing the tailgate to be mechanically opened. Attaching the tailgate on the slurry box 201 so that it is vertically opened ensures that the slurry box 201 does not need additional lateral space to either side. In many applications, the slurry box 201 needs to be unloaded at sites that do not allow for excess horizontal space around the slurry box 201. When closed, the tailgate is sealed to the vacuum tank such that the vacuum tank may maintain vacuum pressure.

The tailgate may be opened using hydraulic force or any other force. In some embodiments, at least one hydraulic cylinder is used to open and close the tailgate. The tailgate is attached to the slurry box 201 by at least one hinge. The tailgate closes to be secured to the vacuum tank and fluidly seals the vacuum tank when it is closed.

The tailgate can be secured against the vacuum tank by force or may use one or more latches. The latches may be manually or mechanically operated. In addition, a safety brace may be attached to the slurry box 201 to ensure the tailgate is forcefully maintained in an open position such that the tailgate may not close due to the force of gravity or due to hydraulic force. The safety brace allows compliance with safety regulations and provides for safety concerns due to a closing tailgate.

The step of opening the 503 the tailgate comprises the steps of unlatching any latches, applying force to cause the tailgate to move to an open position, and applying the safety brace when configured. The open position is typically such that the tailgate is at a 120-degree position relative to the position when fluidly sealed against the vacuum tank. A control such as a handheld remote may be used to cause the tailgate to move to an open position.

The step of dumping 504 the slurry box 201 is the act of raising the slurry box to cause the slurry cuttings to empty from the vacuum tank. The step of dumping 504 the slurry box 201 comprises of raising the slurry box 201 as previously describe in the draining 502 step. The dumping 504 step may proceed once the tailgate has been opened 503. In the dumping 504 step typically both drill cuttings and fluids comprising the slurry cuttings are emptied from the vacuum box.

Draining 502 the unconstrained fluid prior to dumping 504 the slurry box 201 is to control the mass emptied from the vacuum tank. If the vacuum tank was emptied of all slurry cuttings by skipping to the dumping 504 step, the mass of slurry cuttings emptied out of the vacuum tank would be uncontrolled. The mass would be uncontrolled because the slurry cuttings are comprised of solid drill cuttings and fluids. The slurry cuttings is a mix of solid and liquid such that it is in akin to a mud. Dumping such a load of material results in an uncontrolled dump and will result in a mess.

Once the dumping 504 step has been completed, the cleaning 505 step may commence. The step of cleaning 505 the slurry box 201 is generally comprised of using pressurize fluid to spray remaining slurry cuttings from the vacuum tank and washing debris from seals on the vacuum tank. After the slurry box 201 is drained 502 and dumped 504, some slurry cutting will likely remain in the vacuum tank due to adhesion to various surfaces. Pressurize fluid may be used to ensure the remaining slurry cuttings are emptied out of the vacuum tank. The fluid need not be under high pressure, rather any amount of pressure sufficient to spray fluid is all that is required. For example, a garden hose spraying water at 50 PSI could be a sufficient spraying source.

The cleaning 505 step includes the washing of debris from seals on the vacuum tank. Specifically, a seal that causes the tailgate to be fluidly sealed to the vacuum tank, should undergo washing to ensure the tailgate can continue to seal between the tailgate and the vacuum tank. The seal is compressed between the vacuum tank and the tailgate. The washing of the seals may simply include using the pressurized water to spray debris from the seal, or may include the act of scrubbing debris from the seals.

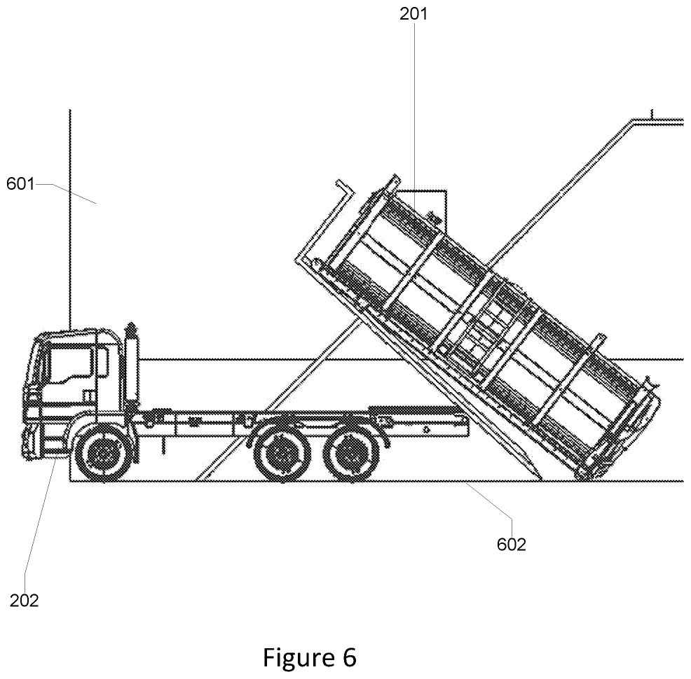

FIG. 6 is a 2D perspective of an exemplary slurry box 201 tilted by a vehicle 202. Shown in the figure is a vehicle 202 and a slurry box 201 next to a building 601. The vehicle 202 as shown in the figure is in the embodiment of a roll-off vehicle. The vehicle 202 has tilted the slurry box 201 to a raised position. For the purpose of dumping 504 the slurry box 201, the slurry box 201 may be held above the ground surface 602. As shown, the slurry box 201 is touching the ground surface 602. The slurry box 201 does not need to touch the ground surface 602 while in the raised position.

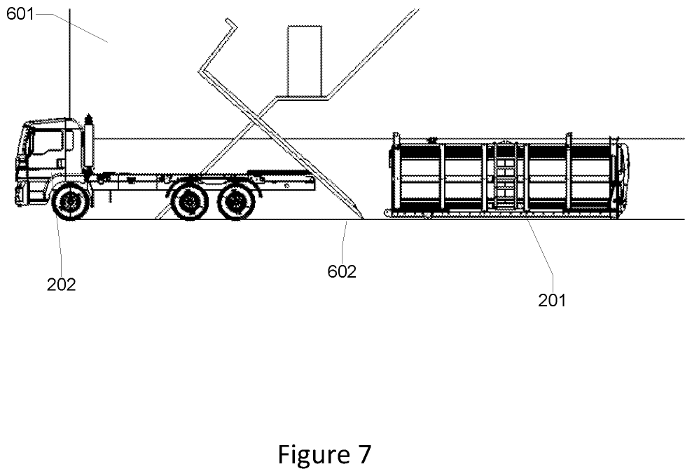

FIG. 7 is a 2D perspective of an exemplary slurry box 201 and vehicle 202.

Shown in the figure is the slurry box 201 placed next to a building 601. The slurry box 201 has been placed by the vehicle 202 on the ground surface 602.

### Explanation of Exemplary Language

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof.

Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A method of using a slurry box comprising:
placing a slurry box near an oil rig, wherein the slurry box is comprised of a vacuum tank, wherein the slurry box can be loaded on a vehicle, wherein the vacuum tank can hold a vacuum pressure, wherein the vacuum tank further comprises an inlet and a vacuum port, wherein the vacuum tank can be filled with slurry cuttings, wherein the oil rig is at an oil rig site;
connecting the slurry box, wherein the inlet is fluidly attached to a slurry cutting outlet attached to the oil rig, wherein the oil rig can express slurry cuttings from the oil rig through the slurry cutting outlet; wherein the vacuum port is fluidly attached to a vacuum source;
charging the vacuum tank, wherein the vacuum source reduces pressure in the vacuum tank to vacuum pressure, wherein the vacuum pressure is less than the pressure within the slurry cutting outlet;
filling the vacuum tank with slurry cuttings, wherein the vacuum pressure in the vacuum tank causes slurry cuttings to be pulled into the vacuum tank from the slurry cuttings outlet until a desired level of slurry cuttings are filled into the vacuum tank;
loading the slurry box onto the vehicle;
transporting the slurry box to a disposal facility;
unloading the vacuum tank, wherein slurry cuttings that have been filled into the vacuum tank are emptied from the vacuum tank at the disposal facility;
transporting the slurry box to the oil rig site; and
delivering the slurry box to the oil rig site, wherein the slurry box is removed from the vehicle at the oil rig site.

2. The method of claim 1, further comprising stacking the slurry box delivered to the oil rig site on top of a second slurry box.

3. The method of claim 1, further comprising storing the slurry box at the oil rig site prior to placing the slurry box.

4. The method of claim 1, further comprising storing the slurry box is at the oil rig site prior to transporting the slurry box to the disposal facility.

5. The method of claim 1, wherein the vehicle is a roll-off vehicle for at least some portion of the transporting.

6. The method of claim 1, wherein the vehicle is a sled for at least some portion of the transporting.

7. The method of claim 1, wherein the vehicle is a truck-trailer combination for at least some portion of the transporting.

8. The method of claim 1, wherein the slurry box has a capability to heat the slurry cuttings in the vacuum tank to a temperature above freezing.

9. The method of claim 1, wherein the slurry box further comprises a vertical tailgate.

10. The method of claim 1, wherein unloading the vacuum tank comprises:
positioning the slurry box at a disposal facility, wherein the slurry box is moved to a location at the disposal facility where the slurry box is to be emptied, wherein slurry cuttings comprise of both drill cuttings and fluids, wherein the vacuum tank has an orifice, wherein a tailgate is attached to the slurry box;
draining the fluids from the vacuum tank by opening the orifice and allowing the fluids to flow through the orifice out of the vacuum tank;
opening the tailgate on the slurry box, wherein a seal is compressed between the tailgate and the vacuum tank when the tailgate is in a closed position;
dumping the slurry box by tilting the slurry box; and
cleaning the slurry box by using pressurize fluid to spray remaining slurry cuttings out of the vacuum tank and by washing the seal.

11. A method of unloading a slurry box comprising:
positioning the slurry box at a disposal facility, wherein the slurry box is moved to a location at the disposal facility where the slurry box is to be emptied, wherein the slurry box is comprised of a vacuum tank, wherein the slurry box can be loaded on a vehicle, wherein the vehicle has a rear, wherein the vacuum tank can hold a vacuum pressure, wherein the vacuum tank further comprises an orifice and a tailgate, wherein the vacuum tank can be filled with slurry cuttings, wherein slurry cuttings comprise of both drill cuttings and fluids;
draining the fluids from the vacuum tank by opening the orifice and allowing the fluids to flow through the orifice out of the vacuum tank;
opening the tailgate on the slurry box, wherein a seal is compressed between the tailgate and the vacuum tank when the tailgate is in a closed position;
dumping the slurry box by tilting the slurry box; and
cleaning the slurry box by using pressurize fluid to spray remaining slurry cuttings out of the vacuum tank and by washing the seal.

12. The method of claim 11, wherein the orifice is an inlet for the vacuum tank.

13. The method of claim 11, further comprising sliding the slurry box back toward the rear of the vehicle.

14. The method of claim 11, further comprising tilting the slurry box prior to draining the fluids.

15. The method of claim 14, further comprising lowering the slurry box prior to opening the tailgate.

16. The method of claim 11, wherein the opening of the tailgate uses hydraulic force.

17. The method of claim 11, wherein the tailgate is secured against the vacuum tank using one or more latches.

18. The method of claim 11, wherein a safety brace is attached to the slurry box to forcefully maintain the tailgate in an open position after opening the tailgate.

19. The method of claim 11, wherein a handheld remote is used to cause the opening of the tailgate.

20. A method of using a slurry box comprising:
placing a slurry box near an oil rig, wherein the slurry box is comprised of a vacuum tank, wherein the slurry box can be loaded on a vehicle, wherein the vacuum tank can hold a vacuum pressure, wherein the vacuum tank further comprises an inlet and a vacuum port, wherein the vacuum tank can be filled with slurry cuttings, wherein the oil rig is at an oil rig site, wherein the slurry box has a capability to heat the slurry cuttings in the vacuum tank to a temperature above freezing;
connecting the slurry box, wherein the inlet is fluidly attached to a slurry cutting outlet attached to the oil rig, wherein the oil rig can express slurry cuttings from the oil rig through the slurry cutting outlet; wherein the vacuum port is fluidly attached to a vacuum source;
charging the vacuum tank, wherein the vacuum source reduces pressure in the vacuum tank to vacuum pressure, wherein the vacuum pressure is less than the pressure within the slurry cutting outlet;
filling the vacuum tank with slurry cuttings, wherein the vacuum pressure in the vacuum tank causes slurry cuttings to be pulled into the vacuum tank from the slurry cuttings outlet until a desired level of slurry cuttings are filled into the vacuum tank;
loading the slurry box onto the vehicle;
transporting the slurry box to a disposal facility, wherein the vehicle is a roll-off vehicle for at least some portion;
unloading the vacuum tank, wherein slurry cuttings that have been filled into the vacuum tank are emptied from the vacuum tank at the disposal facility;
transporting the slurry box to the oil rig site, wherein the vehicle is a roll-off vehicle for at least some portion; and
delivering the slurry box to the oil rig site, wherein the slurry box is removed from the vehicle at the oil rig site.
